(19) United States
(12) Patent Application Publication
(10) Pub. No.: US 2025/0329170 A1
(43) Pub. Date: Oct. 23, 2025

(54) HITCH ANGLE ESTIMATION DEVICE, HITCH ANGLE ESTIMATION METHOD, AND NON-TRANSITORY RECORDING MEDIUM

(71) Applicants: TOYOTA JIDOSHA KABUSHIKI KAISHA, Toyota-shi Aichi-ken (JP); DENSO CORPORATION, Kariya-city Aichi-pref (JP)

(72) Inventors: Hiroki NISHIMURA, Shinagawa-ku Tokyo-to (JP); Masahiro KAWABATA, Koto-ku Tokyo-to (JP)

(73) Assignees: TOYOTA JIDOSHA KABUSHIKI KAISHA, Toyota-shi Aichi-ken (JP); DENSO CORPORATION, Kariya-city Aichi-pref (JP)

(21) Appl. No.: 19/179,089

(22) Filed: Apr. 15, 2025

(30) Foreign Application Priority Data
Apr. 19, 2024 (JP) 2024-068441

(51) Int. Cl. G06V 20/56

(52) U.S. Cl. CPC G06V 20/56

(57) ABSTRACT

A hitch angle estimation device acquires an image of a trailer shot by a camera mounted on a vehicle towing the trailer, and estimates a hitch angle of the trailer based on the image of the trailer by using a model obtained by performing learning using learning data which is a data set of an image of a learning trailer shot by a learning camera mounted on a learning vehicle which tows the learning trailer, and a label indicating the hitch angle of the learning trailer. A difference between an orientation of the learning vehicle calculated based on a GPS signal received by a GPS receiver mounted on the learning vehicle and an orientation of the learning trailer calculated based on a GPS signal received by a GPS receiver mounted on the learning trailer is used as the hitch angle of the learning trailer.

### CROSS-REFERENCE TO RELATED APPLICATIONS

This application claims priority to Japanese Patent Application No. 2024-068441 filed Apr. 19, 2024, the entire contents of which are herein incorporated by reference.

### FIELD

The present disclosure relates to hitch angle estimation device, hitch angle estimation method, and non-transitory recording medium.

### BACKGROUND

PTL 1 (JP2020-535077A) discloses that a DNN (deep neural network) can calculate an angular difference between a front-rear axis of a towing vehicle and a front-rear axis of a trailer.

PTL 1 does not disclose a method for obtaining a hitch angle of a learning trailer which needs to be input to the DNN as learning data as a set with an image at the time of learning of the DNN. If sensor, marker or the like for obtaining the hitch angle of the learning trailer is included in the image used for the learning of the DNN, the learning of the DNN becomes improper, and consequently, at the time of inference, DNN may not be able to appropriately estimate the hitch angle of the trailer based on the image which does not include the sensor, the marker, or the like.

### SUMMARY

In view of the above-described points, it is an object of the present disclosure to provide hitch angle estimation device, hitch angle estimation method, and non-transitory recording medium that can use an appropriate image of a learning trailer which does not include sensor, marker or the like for learning of a model used for estimation of a hitch angle.
(1) One aspect of the present disclosure is a hitch angle estimation device including a processor configured to: acquire an image of a trailer shot by a camera mounted on a vehicle towing the trailer; and estimate a hitch angle of the trailer based on the image of the trailer by using a model obtained by performing learning using learning data which is a data set of an image of a learning trailer shot by a learning camera mounted on a learning vehicle which tows the learning trailer, and a label indicating the hitch angle of the learning trailer, wherein a difference between an orientation of the learning vehicle calculated based on a GPS signal received by a GPS receiver mounted on the learning vehicle and an orientation of the learning trailer calculated based on a GPS signal received by a GPS receiver mounted on the learning trailer is used as the hitch angle of the learning trailer.
(2) Another aspect of the present disclosure is a hitch angle estimation method including: acquiring an image of a trailer shot by a camera mounted on a vehicle towing the trailer; and estimating a hitch angle of the trailer based on the image of the trailer by using a model obtained by performing learning using learning data which is a data set of an image of a learning trailer shot by a learning camera mounted on a learning vehicle which tows the learning trailer, and a label indicating the hitch angle of the learning trailer, wherein a difference between an orientation of the learning vehicle calculated based on a GPS signal received by a GPS receiver mounted on the learning vehicle and an orientation of the learning trailer calculated based on a GPS signal received by a GPS receiver mounted on the learning trailer is used as the hitch angle of the learning trailer.
(3) Another aspect of the present disclosure is a non-transitory recording medium having recorded thereon a computer program for causing a processor to perform a process including: acquiring an image of a trailer shot by a camera mounted on a vehicle towing the trailer; and estimating a hitch angle of the trailer based on the image of the trailer by using a model obtained by performing learning using learning data which is a data set of an image of a learning trailer shot by a learning camera mounted on a learning vehicle which tows the learning trailer, and a label indicating the hitch angle of the learning trailer, wherein a difference between an orientation of the learning vehicle calculated based on a GPS signal received by a GPS receiver mounted on the learning vehicle and an orientation of the learning trailer calculated based on a GPS signal received by a GPS receiver mounted on the learning trailer is used as the hitch angle of the learning trailer.

According to the present disclosure, it is possible to use an appropriate image of a learning trailer which does not include sensor, marker or the like for learning of a model used for estimation of a hitch angle.

### BRIEF DESCRIPTION OF DRAWINGS

FIG. 1 is a view showing an example of a vehicle to which a hitch angle estimation device of a first embodiment is applied.

FIG. 2A is a view of the vehicle 1 and a trailer 2 from above.

FIG. 2B is a view showing an example of an image IM of the trailer 2 shot by a camera 11 mounted on the vehicle 1.

FIG. 3A is a view of a learning vehicle L1 and a learning trailer L2 from above.

FIG. 3B is a view showing an example of components of the learning vehicle L1.

FIG. 3C is a view showing an example of components of the learning trailer L2.

FIG. 4 is a flowchart for explaining an example of a process performed by the hitch angle estimation device of the first embodiment.

### DESCRIPTION OF EMBODIMENTS

Below, referring to the drawings, embodiments of hitch angle estimation device, hitch angle estimation method, and non-transitory recording medium of the present disclosure will be explained.

### First Embodiment

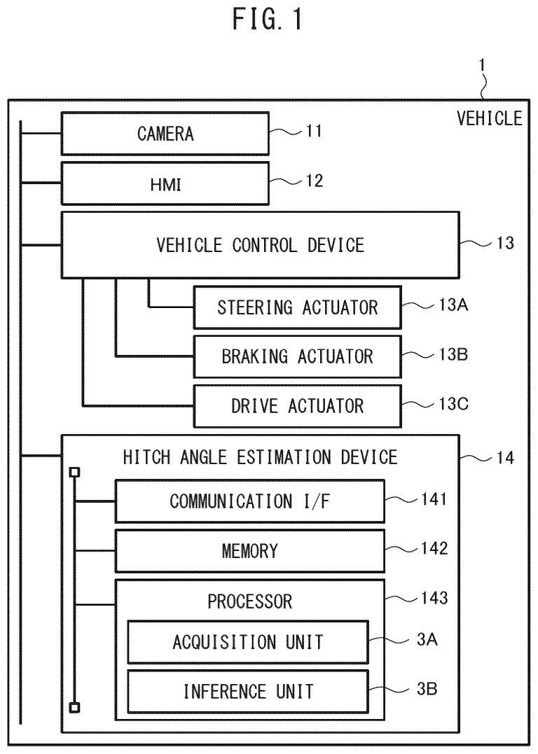

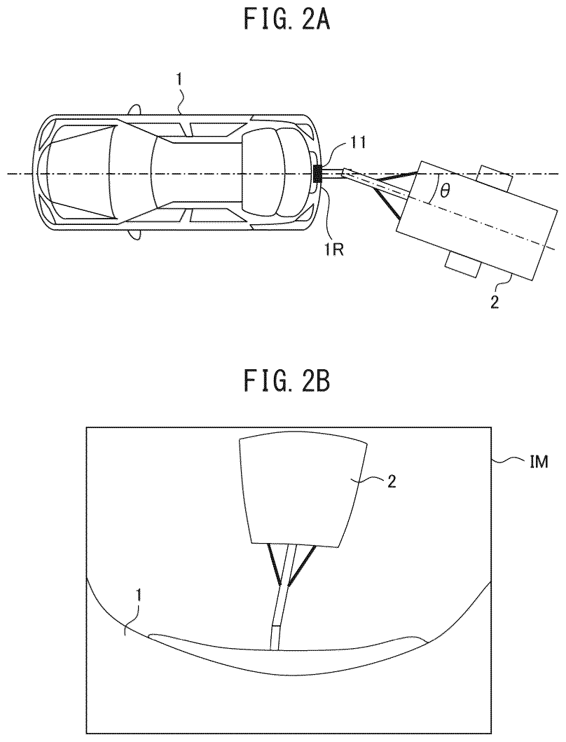

FIG. 1 is a view showing an example of a vehicle 1 to which a hitch angle estimation device 14 of a first embodiment is applied. FIG. 2A and FIG. 2B are views showing an example of a relation between the vehicle 1 shown in FIG. 1 and a trailer 2. Specifically, FIG. 2A is a view of the vehicle 1 and the trailer 2 from above. FIG. 2B is a view showing an example of an image IM of the trailer 2 shot by a camera 11 mounted on the vehicle 1.

In the example shown in FIG. 1, FIG. 2A and FIG. 2B, the vehicle 1 tows the trailer 2. The vehicle 1 includes the camera 11, HMI (Human Machine Interface) 12, vehicle control device 13, steering actuator 13A, braking actuator 13B, drive actuator 13C, and the hitch angle estimation device 14. The camera 11 is disposed, for example, at the rear end 1R of the vehicle 1. The camera 11 shoots the rear (right side of FIG. 2A) of the vehicle 1, and transmits the image (e.g., fisheye lens image, etc.) IM (see FIG. 2B) of the trailer 2 to the hitch angle estimation device 14.

As shown in FIG. 2A and FIG. 2B, the trailer 2 is rotatably connected to the vehicle 1 around a hitch ball (not shown).

The HMI 12 has a function for receiving various operations of a driver of the vehicle 1 or the like, and transmits a signal indicating the operation of the driver of the vehicle 1 to the vehicle control device 13. The vehicle control device 13 controls the steering actuator 13A, the braking actuator 13B and the drive actuator 13C based on the signal transmitted from the HMI 12 or the like.

The hitch angle estimation device 14 is configured by a microcomputer including communication interface (I/F) 141, memory 142, and processor 143. The communication interface 141 includes an interface circuit for connecting the hitch angle estimation device 14 to the camera 11, the HMI 12 and the vehicle control device 13. The memory 142 stores a program used in a process performed by the processor 143 and various data. The processor 143 has a function as an acquisition unit 3A and a function as an inference unit 3B. The acquisition unit 3A acquires the image IM of the trailer 2 shot by the camera 11. The inference unit 3B estimates the hitch angle θ (see FIG. 2A) of the trailer 2 based on the image IM of the trailer 2 acquired by the acquisition unit 3A by using a model to be described later.

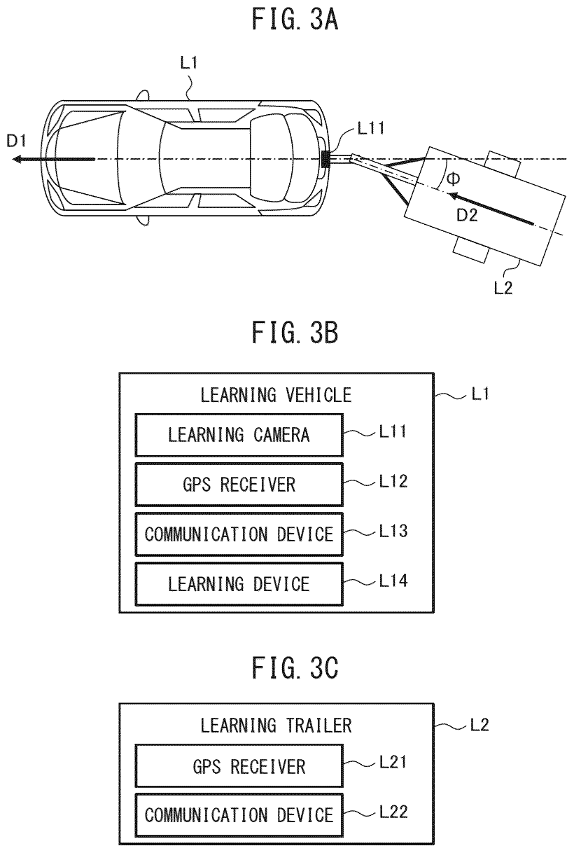

FIG. 3A to FIG. 3C are views showing an example of learning vehicle L1 and learning trailer L2 used for obtaining a model used by the inference unit 3B. Specifically, FIG. 3A is a view of the learning vehicle L1 and the learning trailer L2 from above. FIG. 3B is a view showing an example of components of the learning vehicle L1. FIG. 3C is a view showing an example of components of the learning trailer L2.

In the example shown in FIG. 3A to FIG. 3C, the learning trailer L2 includes GPS (Global Positioning System) receiver L21 and communication device L22. The GPS receiver L21 receives a GPS signal and calculates an orientation D2 [deg] (see FIG. 3A) of the learning trailer L2 based on the GPS signal. The communication device L22 transmits the orientation D2 of the learning trailer L2 calculated by the GPS receiver L21 to the learning vehicle L1.

The learning vehicle L1 includes learning camera L11, GPS receiver L12, communication device L13, and learning device L14. Similar to the camera 11 of the vehicle 1, the learning camera L11 is disposed at the rear end of the learning vehicle L1 and shoots the rear (right side of FIG. 3A) of the learning vehicle L1. The GPS receiver L12 receives the GPS signal and calculates the orientation D1 [deg] of the learning vehicle L1 based on the GPS signal. The communication device L13 receives the orientation D2 of the learning trailer L2 transmitted from the communication device L22 of the learning trailer L2. The learning device L14 calculates a difference (D1-D2) between the orientation D1 of the learning vehicle L1 and the orientation D2 of the learning trailer L2 as the hitch angle Φ (see FIG. 2A) of the learning trailer L2. Furthermore, the learning device L14 generates the model used by the inference unit 3B of the hitch angle estimation device 14 (performs learning of the model). Specifically, the learning device L14 generates the model used by the inference unit 3B of the hitch angle estimation device 14 by performing the learning using learning data which is a data set of the image of the learning trailer L2 shot by the learning camera L11 and a label indicating the hitch angle Φ of the learning trailer L2.

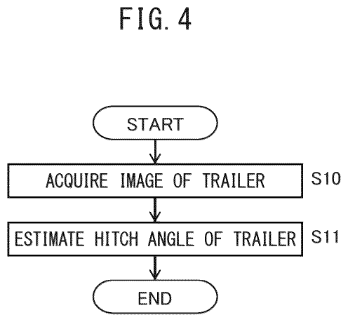

FIG. 4 is a flowchart for explaining an example of the process performed by the hitch angle estimation device of the first embodiment.

In the example shown in FIG. 4, at step S10, the acquisition unit 3A acquires the image IM of the trailer 2 shot by the cameras 11.

At step S11, the inference unit 3B estimates the hitch angle θ of the trailer 2 based on the image IM of the trailer 2 acquired at step S10 by using the model obtained by performing the learning using the learning data which is the data set of the image of the learning trailer L2 shot by the learning camera L11 and the label indicating the hitch angle Φ of the learning trailer L2. The difference (D1-D2) between the orientation D1 of the learning vehicle L1 calculated based on the GPS signal received by the GPS receiver L12 mounted on the learning vehicle L1 and the orientation D2 of the learning trailer L2 calculated based on the GPS signal received by the GPS receiver L21 mounted on the learning trailer L2 is used as the hitch angle Φ of the learning trailer L2.

In the example shown in FIG. 1 to FIG. 4, it is possible to perform the learning of the model used for the estimation of the hitch angle θ of the trailer 2 by using the image of the learning trailer L2 which does not include sensor, marker or the like.

### Second Embodiment

As described above, in the first embodiment (example shown in FIG. 1 to FIG. 4), the learning device L14 which generates the model by performing the learning using the learning data is mounted on the learning vehicle L1.

On the other hand, in a second embodiment, the learning device (learning computer) which generates the model by performing the learning using the learning data may not be mounted on the learning vehicle L1.

In the first embodiment (example shown in FIG. 1 to FIG. 4), the learning camera L11, the GPS receiver L12 and the learning device L14 of the learning vehicle L1 are connected to each other.

On the other hand, in the second embodiment, the learning camera L1 and the learning computer of the learning camera L11 may not be connected, and the GPS receiver L12 and the learning computer of the learning vehicle L1 may not be connected. In other words, in the second embodiment, the image of the learning trailer L2 shot by the learning camera L11 are input to the learning computer by an annotator, for example, and the orientation D1 of the learning vehicle L1 calculated by the GPS receiver L12 is input to the learning computer by the annotator, for example.

In addition, in the first embodiment (the example shown in FIG. 1 to FIG. 4), the learning vehicle L1 includes the communication device L13, and the learning trailer L2 includes the communication device L22.

On the other hand, in the second embodiment, the learning vehicle L1 may not include the communication device L13, and the learning trailer L2 may not include the communication device L22. In other words, in the second embodiment, the orientation D2 of the learning trailer L2 calculated by the GPS receiver L21 is input to the learning computer by, for example, the annotator.

As described above, although the embodiments of the hitch angle estimation device, the hitch angle estimation method, and the non-transitory recording medium of the present disclosure have been described with reference to the drawings, the hitch angle estimation device, the hitch angle estimation method, and the non-transitory recording medium of the present disclosure are not limited to the embodiments described above, and may be appropriately changed without departing from the scope of the present disclosure. The configuration of each example of the embodiment described above may be appropriately combined. In each example of the above-described embodiment, the process performed in the hitch angle estimation device 14 has been described as software process performed by executing the program, but the process performed in the hitch angle estimation device 14 may be process performed by hardware. Alternatively, the process performed by the hitch angle estimation device 14 may be a combination of both software and hardware. Further, the program (program for realizing the function of the processor 143 of the hitch angle estimation device 14) stored in the memory 142 of the hitch angle estimation device 14 may be recorded in a computer-readable storage medium (non-transitory recording medium) such as, semiconductor memory, magnetic recording medium, optical recording medium, or the like for providing, distribution or the like.

1. A hitch angle estimation device comprising a processor configured to:
acquire an image of a trailer shot by a camera mounted on a vehicle towing the trailer; and
estimate a hitch angle of the trailer based on the image of the trailer by using a model obtained by performing learning using learning data which is a data set of an image of a learning trailer shot by a learning camera mounted on a learning vehicle which tows the learning trailer, and a label indicating the hitch angle of the learning trailer,
wherein a difference between an orientation of the learning vehicle calculated based on a GPS signal received by a GPS receiver mounted on the learning vehicle and an orientation of the learning trailer calculated based on a GPS signal received by a GPS receiver mounted on the learning trailer is used as the hitch angle of the learning trailer.

2. A hitch angle estimation method comprising:
acquiring an image of a trailer shot by a camera mounted on a vehicle towing the trailer; and
estimating a hitch angle of the trailer based on the image of the trailer by using a model obtained by performing learning using learning data which is a data set of an image of a learning trailer shot by a learning camera mounted on a learning vehicle which tows the learning trailer, and a label indicating the hitch angle of the learning trailer,
wherein a difference between an orientation of the learning vehicle calculated based on a GPS signal received by a GPS receiver mounted on the learning vehicle and an orientation of the learning trailer calculated based on a GPS signal received by a GPS receiver mounted on the learning trailer is used as the hitch angle of the learning trailer.

3. A non-transitory recording medium having recorded thereon a computer program for causing a processor to perform a process comprising:
acquiring an image of a trailer shot by a camera mounted on a vehicle towing the trailer; and
estimating a hitch angle of the trailer based on the image of the trailer by using a model obtained by performing learning using learning data which is a data set of an image of a learning trailer shot by a learning camera mounted on a learning vehicle which tows the learning trailer, and a label indicating the hitch angle of the learning trailer,
wherein a difference between an orientation of the learning vehicle calculated based on a GPS signal received by a GPS receiver mounted on the learning vehicle and an orientation of the learning trailer calculated based on a GPS signal received by a GPS receiver mounted on the learning trailer is used as the hitch angle of the learning trailer.
